(19) United States
(12) Patent Application Publication
(10) Pub. No.: US 2012/0164454 A1
(43) Pub. Date: Jun. 28, 2012

(54) Diamond Protected Devices and Associated Methods

(76) Inventor: Chien-Min Sung, Tansui (TW)

(21) Appl. No.: 13/312,289

(22) Filed: Dec. 6, 2011

Related U.S. Application Data
(60) Provisional application No. 61/427,394, filed on Dec. 27, 2010.

(51) Int. Cl. B32B 9/00; B05D 1/36

(52) U.S. Cl. 428/408; 427/402

(57) ABSTRACT

Diamond-like carbon (DLC) coated devices and associated methods are provided. In one aspect, for example, a DLC-coated substrate can include a substrate, and a H-doped DLC layer disposed on the substrate, where the DLC layer is doped with a Si material at least along an interface between the substrate and the DLC layer. Additionally, the substrate can include a surface doped layer on the DLC layer opposite the substrate.

### PRIORITY DATA

This application claims the benefit of U.S. Provisional Patent Application Ser. No. 61/427,394, filed on Dec. 27, 2010, which is incorporated herein by reference.

### FIELD OF THE INVENTION

The present invention relates generally to diamond protected devices and associated methods. Accordingly, the present invention involves the field of material science.

### BACKGROUND OF THE INVENTION

Many devices used today are subject to excessive mechanical and/or chemical degradation. Such degradation can include scratching and other forms of wear and tear that, in some cases, can limit the usefulness of the device. For example, touchscreen interfaces for smartphones and personal digital assistants (PDAs) are subject to damage by abrasive forces that scratch and pit the physical user interface. Additionally, oil from the skin of the user can coat the surface and may further facilitate the degradation of the device. Such abrasion and chemical action can cause a reduction in the visual clarity of the underlying electronic display, thus potentially impeding the use and enjoyment of the device.

Various materials have been utilized to increase the durability of such devices. Examples include polymeric coatings or layers that are applied to the touchscreen surface to provide a barrier against degradation. Such layers are often soft and easily damaged, and therefore often need to be periodically replaced. Additionally, such polymeric layers can interfere with the visual clarity of the underlying electronic display, both in terms of distortion and lowered light output. In some cases, polymeric layers can interfere with the touchscreen electronics themselves, thus introducing input distortion. Another traditional approach is to utilize an external case around the device housing. Such a case can limit exposure of a touchscreen to a flat surface because the case is raised slightly above the interface surface of the device. This allows protection against lateral abrasions, but does not protect the surface against point contacts or finger oils.

### SUMMARY OF THE INVENTION

The present invention provides diamond-like carbon (DLC) coated devices and associated methods. In one aspect, for example, a DLC-coated substrate is provided. Such a substrate can include a substrate, and an H-doped DLC layer disposed on the substrate, where the DLC layer is doped with a Si material at least along an interface between the substrate and the DLC layer. Additionally, the substrate can include a surface doped layer on the DLC layer opposite the substrate. In one aspect, the surface doped layer is doped with a hydrophobic dopant. One non-limiting example of a hydrophobic dopant is F. In another aspect, the surface doped layer is doped with a hydrophilic dopant. Nonlimiting examples of hydrophilic dopants include N, O, OH, NH₂ and combinations thereof. In yet another aspect, the surface doped layer is doped with both a hydrophilic dopant and a hydrophobic dopant.

The Si material can be doped along the interface between the substrate and the DLC layer, throughout the entire or substantially the entire DLC layer, or any degree of doping therebetween. Nonlimiting examples of Si materials include Si, Si—O, and combinations thereof.

Various substrate materials are contemplated, and such materials can vary depending on the intended use of the device. Non-limiting examples of substrate materials can include metals, glasses, polymers, ceramics, including without limitation sapphire or yittria stabilized zirconia, toughened ceramics, and combinations thereof. In one aspect, the substrate material can have properties that allow at least about 80% of light impinging on the DLC layer to be transmitted to the underlying substrate.

Numerous substrates and devices are contemplated in various aspects of the present invention. In one aspect, for example, the DLC-coated substrate is a touch screen. In another aspect, the DLC-coated substrate is a media disk. Other nonlimiting examples of

DLC-coated substrates include an eyeglass lens, a wristwatch glass, a cell phone screen, other electronic device screen, and the like.

In another aspect of the present invention, a DLC-protected device is provided. Such a device can include a device housing, a device substrate coupled to the device housing, and a H-doped DLC layer disposed on the device substrate, where the DLC layer is doped with a Si material at least along an interface between the device substrate and the DLC layer. The device can further include a surface doped layer on the DLC layer opposite the device substrate. In another aspect, at least a portion of the device housing is coated with a protective DLC layer.

In yet another aspect, the present invention provides a method of bonding a protective DLC coating to a surface. Such a method can include applying a H-doped DLC layer to a substrate, doping the substrate with a Si material at least along an interface between the substrate and the H-doped DLC layer, and applying a surface dopant to the H-doped DLC layer on a side opposite the substrate.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a cross-section view of a DLC-protected substrate in accordance with one embodiment of the present invention.

FIG. 2 is a cross-section view of a DLC-protected substrate in accordance with another embodiment of the present invention.

FIG. 3 is a cross-section view of a DLC-protected substrate in accordance with yet another embodiment of the present invention.

FIG. 4 is a cross-section view of a DLC-protected device in accordance with another embodiment of the present invention.

### DETAILED DESCRIPTION OF THE INVENTION

Definitions

In describing and claiming the present invention, the following terminology will be used in accordance with the definitions set forth below.

The singular forms “a,” “an,” and, “the” include plural referents unless the context clearly dictates otherwise. Thus, for example, reference to “a dopant” includes reference to one or more of such dopants, and reference to “the diamond layer” includes reference to one or more of such layers.

As used herein, “vapor deposited” refers to materials which are formed using vapor deposition techniques. “Vapor deposition” refers to a process of forming or depositing materials on a substrate through the vapor phase. Vapor deposition processes can include any process such as, but not limited to, chemical vapor deposition (CVD) and physical vapor deposition (PVD). A wide variety of variations of each vapor deposition method can be performed by those skilled in the art. Examples of vapor deposition methods include hot filament CVD, rf-CVD, laser CVD (LCVD), laser ablation, conformal diamond coating processes, metal-organic CVD (MOCVD), sputtering, thermal evaporation PVD, ionized metal PVD (IMPVD), electron beam PVD (EBPVD), reactive PVD, cathodic arc, and the like.

As used herein, “chemical vapor deposition,” or “CVD” refers to any method of chemically forming or depositing diamond particles in a vapor form upon a surface. Various CVD techniques are well known in the art.

As used herein, “physical vapor deposition,” or “PVD” refers to any method of physically forming or depositing diamond particles in a vapor form upon a surface. Various PVD techniques are well known in the art.

As used herein, “diamond” refers to a crystalline structure of carbon atoms bonded to other carbon atoms in a lattice of tetrahedral coordination known as sp³ bonding. Specifically, each carbon atom is surrounded by and bonded to four other carbon atoms, each located on the tip of a regular tetrahedron. Further, the bond length between any two carbon atoms is 1.54 angstroms at ambient temperature conditions, and the angle between any two bonds is 109 degrees, 28 minutes, and 16 seconds although experimental results may vary slightly. The structure and nature of diamond, including its physical and electrical properties are well known in the art.

As used herein, “distorted tetrahedral coordination” refers to a tetrahedral bonding configuration of carbon atoms that is irregular, or has deviated from the normal tetrahedron configuration of diamond as described above. Such distortion generally results in lengthening of some bonds and shortening of others, as well as the variation of the bond angles between the bonds. Additionally, the distortion of the tetrahedron alters the characteristics and properties of the carbon to effectively lie between the characteristics of carbon bonded in sp³ configuration (i.e. diamond) and carbon bonded in sp² configuration (i.e. graphite). One example of material having carbon atoms bonded in distorted tetrahedral bonding is amorphous diamond.

As used herein, “diamond-like carbon” refers to a carbonaceous material having carbon atoms as the majority element, with a substantial amount of such carbon atoms bonded in distorted tetrahedral coordination. Diamond-like carbon (DLC) can typically be formed by PVD processes, although CVD or other processes could be used such as vapor deposition processes. Notably, a variety of other elements can be included in the DLC material as either impurities, or as dopants, including without limitation, hydrogen, sulfur, phosphorous, boron, nitrogen, silicon, tungsten, etc.

As used herein, “amorphous diamond” refers to a type of diamond-like carbon having carbon atoms as the majority element, with a substantial amount of such carbon atoms bonded in distorted tetrahedral coordination. In one aspect, the amount of carbon in the amorphous diamond can be at least about 90%, with at least about 20% of such carbon being bonded in distorted tetrahedral coordination. Amorphous diamond also has a higher atomic density than that of diamond (176 atoms/cm³). Further, amorphous diamond and diamond materials contract upon melting.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

The Invention

Various substrates, particularly those involving repeated contact, can benefit by the application of a hardened surface. Such a surface can increase the durability of devices utilizing such substrates, both in terms of chemical and mechanical protection. It can, however, be difficult to couple a hardened surface such as a diamond-like carbon (DLC) to many substrate materials (e.g. glass). The present invention discloses techniques for coupling a hardened surface to such substrate materials, including the substrates themselves and devices incorporating such coated substrates.

In one aspect, for example, a DLC-coated substrate can include a substrate and a H-doped DLC layer disposed on the substrate, where the DLC layer is doped with a Si material at least along an interface between the substrate and the DLC layer. The DLC-coated substrate can also include a surface doped layer on the DLC layer opposite the substrate. Thus the DLC layer is disposed on the substrate to increase the mechanical and/or chemical durability of the substrate. The DLC layer can be disposed on the entire substrate, or a portion thereof. Additionally, depending on the configuration and intended use of the substrate, the DLC layer can be deposited on one or more sides.

Various substrates and substrate materials are contemplated for used according to aspects of the present invention. A substrate can be any surface or material that can benefit from protection by a DLC coating. Nonlimiting examples of substrates can include metals and metal alloys; glass materials including soda glass; polymeric materials including polycarbonates, PET, and the like; ceramics including quartz, sapphire, and the like; and mixtures and combinations thereof. In one aspect, the substrate can be in some way manipulatable, and as such the DLC layer can be configured to not significantly interfere with the substrate's intended purpose. For example, certain substrates are light sensitive, and thus the DLC layer should be as translucent as possible. Generally, a greater proportion of sp3 bonding in a DLC material can increase both the hardness and the translucence of the material. In one specific aspect, the DLC layer can transmit at least about 80% of light impinging on the DLC layer through to the underlying substrate. This can also be beneficial for substrates that transmit light, as the light signal from the substrate will not be significantly filtered by the DLC layer. In another aspect, the substrate can be a touch screen. In such a case, the DLC layer is configured to not significantly interfere with the touch mechanics of the screen, whether they be capacitive, conductive, photosensitive, or the like, while at the same time allowing transmission of light from the screen to the user. In one aspect a touchscreen can include a DLC coating on a transparent conductor, such as, for example, an ITO electrode.

In another aspect, the substrate can be a media disk. Such disks can include any form of media including, without limitation, compact disks, DVDs, laser disks, Blu-Ray disks, and the like. A DLC layer coated on at least the read surface of such media disks can decrease the incidence of scratching and damage to the disk both in and out of the disk player/recorder. This is particularly beneficial for media disks such as Blu-Ray where the data layers are closer to the surface as compared to standard DVD disks and are thus more prone to scratching. The DLC layer associated with a media disk can be an additional coating on the polymeric disk, or the DLC layer can substitute for a portion of the polymeric material. Numerous polymeric materials are traditionally used for media disks, one nonlimiting example being polycarbonate.

The DLC layer can additionally be utilized to protect various substrates associated with devices that are commonly damaged via mechanical and chemical exposure. Other nonlimiting examples include eyeglass or sunglass lenses, wristwatch glasses, cell phone screens and bodies, portable music player screens and bodies, touch panels, and the like.

In some aspects, effective coverage of a substrate may be provided without actually covering the entire substrate surface. For example, a grid or other pattern of DLC may be provided on the substrate surface with either hydrophobic or hydrophilic doped DLC surfaces. Numerous patterns and spatial arrangements may be used in this regard. In one aspect, the spatial arrangement or pattern may cover less than the entire surface, such as from about 70% to about 90% of the surface, while still providing effective coverage of the entire surface. Further, the spacing between DLC layer segments may be from about 20 microns apart to about 500 microns apart. In one aspect, the segments may be substantially square segments. In another aspect, the segments may be 100 microns square and may be separated by 100 microns of uncoated substrate between each square.

Numerous types of hardened surface materials are contemplated for use as protective layers according to aspects of the present invention. Non-limiting examples include amorphous carbon, diamond-like carbon (DLC), polycrystalline diamond, crystalline diamond, single crystal diamond, and the like. In one aspect, the hardened surface layer can be an amorphous carbon layer. In another aspect, the hardened surface layer can be a DLC layer. The following discussion describes DLC materials as the protective layer. It is noted that this is for convenience, and that the discussion applies to equivalent materials where relevant.

The thickness of the DLC layers according to aspects of the present invention can be of various different thicknesses, depending on the intended use of the device and the nature of the particular DLC material being used. For example, for those aspects whereby the DLC layer is coated on a touch screen, the thickness of the DLC layer can be any thickness that allows the touch screen to be manipulated through the DLC. In some aspects, the DLC layer can be limited in thickness due to manufacturing or cost issues. For example, DLC layers having a thickness that is significantly greater than what is necessary to provide protection and allow functionality of the device may be prohibitively expensive to manufacture in relation to the cost of the device, and as such may have a maximum desired thickness. In some aspects, particularly those where the thickness of the device is to be minimized, it can be beneficial to utilize a DLC layer that is no thicker than necessary to provide the protective function. That being said, in one aspect the DLC layer can have a thickness of from about 10 nm to about 500 μm. In another aspect the DLC layer can have a thickness of from about 10 nm to about 10 μm. In yet another aspect the DLC layer can have a thickness of from about 10 nm to about 1 μm.

It should be understood that the following is a very general discussion of diamond deposition techniques that may or may not apply to a particular layer or application, and that such techniques may vary widely between the various aspects of the present invention. Generally, diamond layers, including DLC layers, may be formed by any means known, including various vapor deposition techniques. Any number of known vapor deposition techniques may be used to form these diamond layers. Common vapor deposition techniques include chemical vapor deposition (CVD) and physical vapor deposition (PVD), although any similar method can be used if similar properties and results are obtained. In one aspect, CVD techniques such as hot filament, microwave plasma, oxyacetylene flame, rf-CVD, laser CVD (LCVD), metal-organic CVD (MOCVD), laser ablation, conformal diamond coating processes, and direct current arc techniques may be utilized. Typical CVD techniques use gas reactants to deposit the diamond or diamond-like material in a layer, or film. These gases generally include a small amount (i.e. less than about 5%) of a carbonaceous material, such as methane, diluted in hydrogen. A variety of specific CVD processes, including equipment and conditions, as well as those used for semiconductor layers, are well known to those skilled in the art. In another aspect, PVD techniques such as sputtering, cathodic arc, and thermal evaporation may be utilized. Additionally, molecular beam epitaxy (MBE), atomic layer deposition (ALD), and the like can additionally be used. Further, specific deposition conditions may be used in order to adjust the exact type of material to be deposited, whether DLC, amorphous diamond, or pure diamond.

In some aspects a nucleation enhancer layer can be formed on the growth surface of a substrate in order to improve the quality and deposition time of the diamond layer. In one aspect, a diamond layer can be formed by depositing applicable nuclei, such as diamond nuclei, on a diamond growth surface of a substrate and then growing the nuclei into a film or layer using a vapor deposition technique. In one aspect of the present invention, a nucleation enhancer layer can be coated upon the substrate to enhance the growth of the diamond layer. Diamond nuclei are then placed upon the nucleation enhancer layer, and the growth of the diamond layer proceeds via CVD.

A variety of suitable materials will be recognized by those in skilled in the art that can serve as a nucleation enhancer. In one aspect of the present invention, the nucleation enhancer can include, without limitation, metals, metal alloys, metal compounds, carbides, carbide formers, and mixtures thereof. In another aspect, the nucleation enhancer layer can be a carbide former layer including a carbide former material. Examples of carbide former materials may include, without limitation, tungsten (W), tantalum (Ta), titanium (Ti), zirconium (Zr), chromium (Cr), molybdenum (Mo), silicon (Si), and manganese (Mn). Additionally, examples of carbides include tungsten carbide (WC), silicon carbide (SiC), titanium carbide (TiC), zirconium carbide (ZrC), and mixtures thereof among others. In one specific aspect, the carbide former layer can be Ti. In another specific aspect, the carbide former layer can be Cr. In one specific aspect, the nucleation enhancing layer can be SiC. It should be noted that a carbide former layer can be utilized to enhance the deposition of a diamond layer, a carbon layer, a boron nitride layer, or an additional material such as a heat spreader material upon one or more of the aforementioned layers. Additionally, a carbide former layer, and/or a thin layer of the above-recited materials can be utilized to improve bonding and/or adhesion between layers, such as the DLC layer and substrate, and many not necessarily involve enhanced nucleation in all cases. For example, carbide formers may form a carbide bond with DLC and then form a chemical bond or a diffusion bond (i.e. mechanical hold) with the substrate depending on the type of substrate material used.

A nucleation enhancer layer or bonding/adhesion enhancer layer, or a carbide former layer, when used, should generally be thin enough that it does not to adversely affect the desired properties of the device. In one aspect, the thickness of these layers may be less than about 0.5 micrometers. In another aspect, the thickness may be less than about 10 nanometers. In yet another aspect, the thickness is less than about 5 nanometers. In a further aspect of the invention, the thickness is less than about 3 nanometers.

As has been described, diamond materials having higher proportions of sp3 bonds have increased hardness and light transmission properties. Various methods can be employed that can affect the sp3 content of the diamond in the diamond layer that is created by vapor deposition techniques. For example, reducing the methane flow rate and increasing the total gas pressure during the early phase of diamond deposition can decrease the decomposition rate of carbon, and increase the concentration of hydrogen atoms. Thus a significantly higher percentage of the carbon will be deposited in a sp³ bonding configuration, and thus the quality of the diamond nuclei formed can be increased. Additionally, the nucleation rate of diamond particles deposited on a growth surface of the substrate or the nucleation enhancer layer can be increased in order to reduce the amount of interstitial space between growing diamond particles. Examples of ways to increase nucleation rates include, but are not limited to; applying a negative bias in an appropriate amount, often about 100 volts, to the growth surface; polishing the growth surface with a fine diamond paste or powder, which may partially remain on the growth surface; and controlling the composition of the growth surface such as by ion implantation of C, Si, Cr, Mn, Ti, V, Zr, W, Mo, Ta, and the like by PVD or PECVD. PVD processes are typically at lower temperatures than CVD processes and in some cases can be below about 250° C. such as about 150° C. Other methods of increasing diamond nucleation will be readily apparent to those skilled in the art.

In one aspect of the present invention, the diamond layer can be formed as a conformal diamond layer. Conformal diamond coating processes can provide a number of advantages over conventional diamond film processes. Conformal diamond coating can be performed on a wide variety of substrates, including non-planar substrates. A growth surface can be pretreated under diamond growth conditions in the absence of a bias to form a carbon film. The diamond growth conditions can be conditions that are conventional CVD deposition conditions for diamond without an applied bias. As a result, a thin carbon film can be formed which is typically less than about 100 angstroms. The pretreatment step can be performed at almost any growth temperature such as from about 200° C. to about 900° C., although lower temperatures below about 500° C. may be preferred. Without being bound to any particular theory, the thin carbon film appears to form within a short time, e.g., less than one hour, and is a hydrogen terminated amorphous carbon.

Following formation of the thin carbon film, the growth surface can then be subjected to diamond growth conditions to form a conformal diamond layer. The diamond growth conditions can be those conditions which are commonly used in traditional CVD diamond growth. However, unlike conventional diamond film growth, the diamond film produced using the above pretreatment steps results in a conformal diamond film that typically begins growth substantially over the entire growth surface with substantially no incubation time. In addition, a continuous film, e.g. substantially no grain boundaries, can develop within about 80 nm of growth. Diamond layers having substantially no grain boundaries may move heat more efficiently than those layers having grain boundaries.

As has been described, the inventor has discovered that Si material within the diamond lattice can facilitate the deposition and retention of diamond material on various substrates. This doping process can be particularly effective in bonding a DLC layer to silica glass. A Si network can thus be positioned within the DLC lattice to facilitate the bonding transition between the silica glass and the DLC material. This is possible due to the ability for the silica network of the glass to interpenetrate with the carbon network of the DLC material. The Si network essentially becomes an extension of the silica network of the glass to improve the adhesion between the two materials. Additionally, the carbon-silica network can strengthen the silica glass surface by mending micro-cracks in the glass surface that would otherwise propagate. As such, the DLC material layer can in some aspects be used to strengthen the glass substrate. Reinforcement of the glass against breakage with the DLC layer can be valuable for a number of uses. In one aspect, the present invention encompasses a method of strengthening or reinforcing a glass substrate using a doped DLC layer as recited herein, and further encompasses such reinforced glass products. Non-limiting examples of specific product uses may include lenses, viewing screens, automobile windows, protective glass panels, visors, or any other glass product that might be exposed to potential impact.

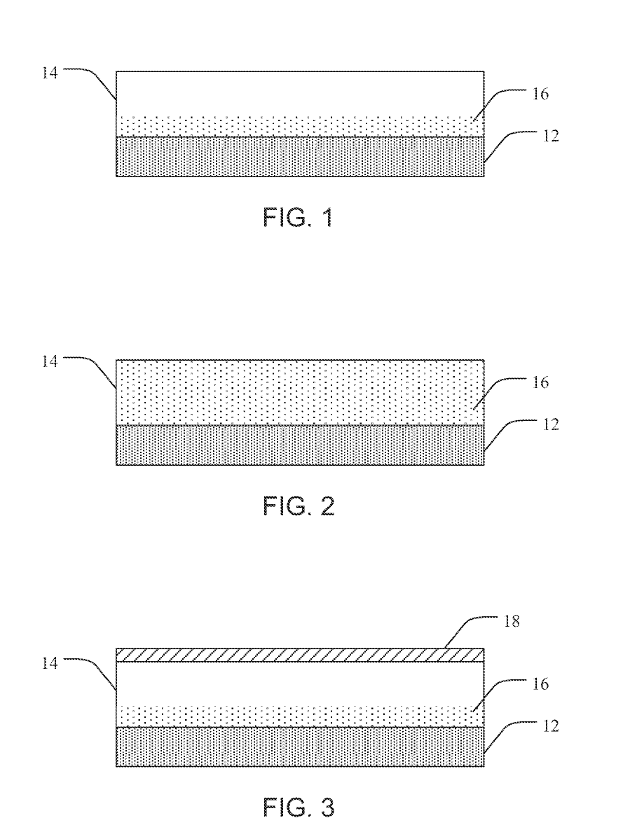

The Si material that is introduced into the DLC layer can be any form of Si material capable of doping. Non-limiting examples include Si, Si—O, Si—H, Si—C, and combinations thereof. The Si material can be introduced during the deposition of the DLC layer, or it can be introduced into the DLC layer following deposition. Additionally, the Si material can be present in only a portion of the DLC layer, or the Si material can be present in substantially all of the DLC layer. In some embodiments, the Si material may interpenetrate the C-H network of the DLC. For example, in one aspect FIG. 1 shows a substrate 12 having a DLC 14 layer deposited thereon. The Si material 16 is concentrated in the DLC layer 14 in a region near the substrate 12. FIG. 2 shows another aspect of a substrate 12 having a DLC 14 layer deposited thereon and a Si material 16 dispersed evenly throughout the DLC layer 14. In yet another aspect, the Si material can have an uneven distribution throughout the DLC layer (not shown). For example, the Si material can be more concentrated near a boundary region as compared to other regions of the DLC layer. One example of a boundary region can include the interface between the substrate and the DLC region. Another example of a boundary region can include the region of the DLC layer in proximity to the surface coating. Various surface dopants may have but a single bond, and thus the Si dopant can increase the hardness of the DLC layer along such a region.

A variety of surface coatings are contemplated and such coatings can vary depending on the desired properties of the exposed portion of the DLC layer. For example, if the device is to be used in environments where water will be present, the surface coating can be a hydrophobic coating to reduce water accumulation on the DLC layer. Thus in one aspect the surface of the DLC layer can be doped with a hydrophobic dopant. One non-limiting example of a hydrophobic dopant is F, H, or Cl. If the device is in contact with human skin as would be the case for a touchscreen, the surface coating can be a hydrophilic coating to reduce the accumulation of skin oils. As such, in one aspect, the surface of the DLC layer can be doped with a hydrophilic dopant. Non-limting examples of hydrophilic dopants include N, O, OH, NH₂, and combinations thereof. In one specific aspect, the hydrophilic dopant can be N. In another specific aspect, the hydrophilic dopant can be O. Additionally, it is contemplated that for some applications the surface coating can include both a hydrophilic and a hydrophobic dopant. Dopants can be introduced into the DLC layer at a variety of concentrations. In one aspect, for example, a dopant can be present in the DLC layer at from about 10 to about 30 atomic %. In another aspect, the dopant can be present in the DLC layer at from about 20 to about 40 atomic %. In yet another aspect, the dopant can be present in the DLC layer at from about 10 to about 50 atomic %. In one specific aspect, hydrogen can be present in the DLC layer at from about 40 to about 50 atomic % to increase light transmission and improve bonding strength of the substrate. In other aspect, hydrogen can be present at less than about 40 atomic %.

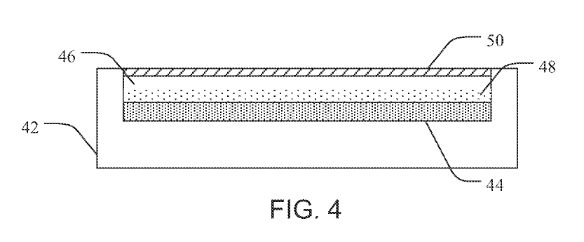

In some embodiments, the dopant concentration in the DLC layer can be graded in various concentrations through the DLC layer. In one aspect, the hydrophobic dopant, for example, F, or the hydrophilic dopant, for example, N, can be graded from a concentration of from about 0 atomic % in one location to about 40 atomic % in another location. In another aspect, the concentration can be graded from about 0 atomic % to about 20 atomic %. In some aspects, the gradient may have a lower concentration at a point near the substrate to which the doped DLC layer is attached and a higher concentration at a point near an outer or exposed surface of the DLC layer. In other cases, the gradient may be opposite. In yet further embodiments, the gradient may be patterned either vertically or horizontally through the DLC layer in order to achieve a desired function, property, or characteristic. Various devices are contemplated that include the protective DLC layers according to aspects of the present invention. In one aspect, as is shown in FIG. 4, a DLC-protected device can include a device housing 42 and a device substrate 44 coupled to the device housing 42. A H-doped DLC layer 46 is disposed on the device substrate 44, and the DLC layer 46 is doped with a Si material 48 at least along an interface between the device substrate 44 and the DLC layer 46. The device can also include a surface doped layer 50 on the DLC layer 46 opposite the device substrate 44. Additionally, in some aspects, at least a portion of the device housing is coated with a protective DLC layer (not shown). As has been described, device that can benefit from such DLC protection include touchscreens, cellphones, computers, watches, eyeglasses and sunglasses, and the like.

### EXAMPLES

The following examples illustrate various techniques of making DLC-protected devices according to aspects of the present invention. However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Examples provide further detail in connection with several specific embodiments of the invention.

### Example 1

Silane or Tetramethylsilane is pyrolyzed on a glass surface to deposit a silicon-rich interface. A layer of DLC is coated onto the silicon-rich surface using RFCVD with acetylene and hydrogen. CF₄ gas is added to the RFCVD gas mixture to apply a finishing surface on the DLC layer.

### Example 2

F doped DLC is coated on glass substrate of touch panel for tribological, hydrophobic and increasing the sensitive of touch panel operation applications. The F doped DLC is coated directly on glass substrate to increasing the transmittance of visible light to more than 85%. The content of F is about 10 to 30 at %. The thickness of FDLC is 10˜500 nm. The hardness of F doped DLC is more than 5 GPa.

### Example 3

H doped DLC is coated on compact disks, DVDs and Blu-Ray disks for scratching resistance application. The transmittance of HDLC is more than 85% of visible light. The content of H is about 10 to 40 at %. The thickness of FDLC is 10˜500 nm. The hardness of F doped DLC is more than 5 GPa.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A DLC-coated substrate, comprising:
a substrate;
a H-doped DLC layer disposed on the substrate, the DLC layer being doped with a Si material at least along an interface between the substrate and the DLC layer; and
a surface doped layer on the DLC layer opposite the substrate.

2. The DLC-coated substrate of claim 1, wherein the surface doped layer is doped with a hydrophobic dopant.

3. The DLC-coated substrate of claim 2, wherein the hydrophobic dopant is F.

4. The DLC-coated substrate of claim 1, wherein the surface doped layer is doped with a hydrophilic dopant.

5. The DLC-coated substrate of claim 4, wherein the hydrophilic dopant includes a member selected from the group consisting of N, O, OH, NH₂ and combinations thereof.

6. The DLC-coated substrate of claim 1, wherein the surface doped layer is doped with both a hydrophilic dopant and a hydrophobic dopant.

7. The DLC-coated substrate of claim 1, wherein the Si material includes a member selected from the group consisting of Si, Si—O, and combinations thereof.

8. The DLC-coated substrate of claim 1, wherein the Si material is doped substantially throughout the DLC layer.

9. The DLC-coated substrate of claim 1, wherein the substrate includes a member selected from the group consisting of metals, glasses, polymers, and combinations thereof.

10. The DLC-coated substrate of claim 1, wherein at least about 80% of light impinging on the DLC layer is transmitted to the underlying substrate.

11. The DLC-coated substrate of claim 1, wherein the substrate is a touch screen.

12. The DLC-coated substrate of claim 1, wherein the substrate is a media disk.

13. The DLC-coated substrate of claim 1, wherein the substrate is a member selected from the group consisting of an eyeglass lens, a wristwatch glass, and a cell phone screen.

14. The DLC-coated substrate of claim 1, further including a layer of SiC disposed between the substrate and the H-doped DLC layer.

15. A DLC-protected device, comprising
a device housing;
a device substrate coupled to the device housing;
a H-doped DLC layer disposed on the device substrate, the DLC layer being doped with a Si material at least along an interface between the device substrate and the DLC layer; and
a surface doped layer on the DLC layer opposite the device substrate.

16. The DLC-protected device of claim 15, wherein at least a portion of the device housing is coated with a protective DLC layer.

17. The DLC-protected device of claim 15, wherein the surface doped layer is doped with a hydrophobic dopant.

18. The DLC-protected device of claim 15, wherein the surface doped layer is doped with a hydrophilic dopant.

19. The DLC-protected device of claim 15, wherein the Si material includes a member selected from the group consisting of Si, Si—O, and combinations thereof.

20. A method of bonding a protective DLC coating to a surface, comprising:
applying a H-doped DLC layer to a substrate;
doping the substrate with a Si material at least along an interface between the substrate and the H-doped DLC layer; and
applying a surface dopant to the H-doped DLC layer on a side opposite the substrate.

21. The method of claim 20, wherein the surface dopant includes a member selected from the group consisting of hydrophobic dopants, hydrophilic dopants, and combinations thereof.

22. The method of claim 20, wherein the Si material includes a member selected from the group consisting of Si, Si—O, and combinations thereof.
